(19) United States
(12) Patent Application Publication
(10) Pub. No.: US 2006/0143032 A1
(43) Pub. Date: Jun. 29, 2006

(54) Advanced electronic notification for a mailpiece

(75) Inventors: Thomas J. Foth, Trumbull, CT (US); Cornelius S. McNab, Cambridge, MA (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/027,175

(22) Filed: Dec. 29, 2004

(51) Int. Cl. G06Q 99/00; G06F 17/00

(52) U.S. Cl. 705/1; 705/410

(57) ABSTRACT

A system and method for providing mailpiece notification to a mailpiece recipient prior to delivery of the mailpiece from a postal carrier system in which a database is accessible by the postal carrier system that contains a recipient's prescribed mailpiece address information and preferred communication channel for receiving the advanced notification regarding impending delivery of the mailpiece. A postal carrier system receives information relating to at least the subject matter, the addressee and a web link relating to information for the mailpiece being processed in the postal carrier mailpiece delivery system and then determines whether the addressee information present on the deposited mailpiece matches a recipient's addressee information prescribed in the database. When a match is determined an electronic notification is sent to the mailpiece recipient via the prescribed at least one communication channel notifying the mailpiece recipient of the subject matter for the mailpiece currently deposited with the postal carrier system for delivery to the recipient and as well as providing the related web link to the recipient.

### I. FIELD OF THE INVENTION

The invention relates to electronic processing of mailpiece information, and more particularly to, providing electronic notification to a mailpiece recipient that includes a web link relating to the mailpiece sent to the recipient.

### II. BACKGROUND OF THE INVENTION

In the past the production of mail required a number of steps that must be coordinated in order for all the elements to come together and to meet the postal service pickup deadlines and the mailer's distribution schedules. The ability to track the production floor operations was essential to ensure that service level agreements are met. This in turn drove a need to provide a way for a customer owning high-speed mailing equipment to transfer customer data from their equipment based on real-time measurements and data collection. The data collected then needed to be transferred typically over a localized network or over the internet to a data processing system.

In the past, the data collection mechanisms were independent elements and storage mechanisms, which often implemented incompatible and disconnected data sources that could not be brought together to provide an overall view of the mail processing processes. Typically, data was provided using dedicated programs and work stations requiring constant presence by the user on the work floor.

It was often typical, that customers of the postal carrier (e.g., mailers) had multiple mailing sites but had no means to aggregate the mail piece data from each of those sites. Additionally, some customers maintained mixed vendor shops each having a mailing system using mailing data that was incompatible relative to one another. Thus, the mailing data present at each of the aforementioned sites could not be aggregated between one another to enable a unified view of all the customers mailing operations.

Further, it has proven desirable that a user (mail sender or recipient) may often find it necessary to review the details on a particular mail piece that has passed through a mailing system (e.g., the USPS). One such objective to do so would be to track and trace a mail piece using minimal information.

To accomplish this objective, tracking and tracing mail pieces required a unique identifier for each mail piece in order for it to recognized. However, the majority of mail pieces do not have such a unique identifier thus obviating tracking and tracing of such mail pieces. The United States Postal Service (USPS) did offer options (registered/certified mail) to provide individual mail tracking which was perfumed via optical scanning of the mailpiece as it progressed through the USPS. However, these options were costly and only provided tracking at the beginning and end of the postal distribution cycle and relied on the cumbersome process of having to integrate with the scanning of the mailpieces to provide mailpiece identification.

One prior art attempt to overcome the above deficiencies in tracking individual mail pieces was to assign a unique code to each mail piece (e.g., on mail pieces envelope). This approach is currently is use by various private carriers (e.g., FedEx, UPS, etc.). However, this approach is deficient in that the unique code is not shared amongst various postal couriers and requires significant investment by each private carrier to utilize it's own unique codes (e.g., requires infrastructures of scanners dedicated for it's unique code).

Additionally, there was no known method for identifying mailpieces and the contents of a mailpiece prior to its processing in the USPS (since optical scanning of the mailpiece was required) so as to provide notification to an intended recipient regarding the impending mailpiece delivery. If presented with this mailpiece information, the recipient may then instruct the USPS to modify, change or cancel the impending delivery of the mailpiece before the mailpiece even begins processing in the USPS.

Accordingly, an object of the present invention is to provide a mail carrier (e.g., the USPS) the ability to provide electronic notification to an intended mailpiece recipient regarding the impending mailpiece delivery prior to the processing of the mailpiece in the mail carrier system so that an intended mailpiece recipient may instruct the USPS to modify, change or cancel the impending delivery of the mailpiece before the mailpiece begins processing in the USPS.

### III. SUMMARY OF THE INVENTION

The present invention relates to a system and method for providing electronic mailpiece notification to a mailpiece recipient prior to physical delivery of the mailpiece from a postal carrier mailpiece delivery system. The present invention method includes the step of providing a database that is accessible by the postal carrier system containing a mailpiece recipient's prescribed mailpiece addressee information and preferred electronic communication channel for receiving the advanced notification regarding a mailpiece being processed for delivery to the mailpiece recipient.

A postal carrier system receives information, preferably from a mailer and in electronic form, indicating the subject matter for each mailpiece that is deposited with the postal carrier for delivery to mailpiece recipients along with preferably the name of the intended recipient printed upon each mailpiece along with preferably the postnet (or other identifier printed on the mailpiece) for each intended recipient. Also preferably included is a Uniform Resource Identifier (URI) referencing a networked resource, such as a web page, that relates to the mailpiece that is deposited with the postal carrier. It is noted that this information is received in the postal carrier system without requiring optical scanning of a mailpiece, thus there in no need to interfere, or integrate with, the optical scanning equipment used by the postal carrier system for processing mailpieces. Thus, the present invention method is independent of any scanning procedures used in a postal carrier system for acquiring addressee information form a mailpiece.

A determination is then performed as to whether the addressee information present on a mailpiece deposited for delivery with a postal carrier system matches a recipient's addressee information prescribed in the database. When a match is determined, an electronic notification is sent to the mailpiece recipient via the prescribed at least one communication channel notifying the mailpiece recipient of the subject matter of the mailpiece and also providing the recipient with the aforesaid URI relating to the mailpiece that is to be processed or is currently being processed for delivery to the recipient in the postal carrier system.

### IV. BRIEF DESCRIPTION OF THE DRAWINGS

The above and other objects of the present invention will be apparent upon consideration of the following detailed description, taken in conjunction with the accompanying drawings, in which like reference numerals refer to like parts throughout, and in which:

FIG. 1 is a system level diagram depicting some of the system level components utilized in the method of the present invention;

FIGS. 2 and 3 are flow charts depicting the method of the present invention for providing advanced notification indicating mailpiece contents and a related URI to the intended mailpiece recipient; and

FIG. 4 is an exemplary email message sent to an intended recipient providing advanced notification of a mailpiece according to the present invention.

### V. DETAILED DESCRIPTION OF THE PREFERRED EMBODIMENT

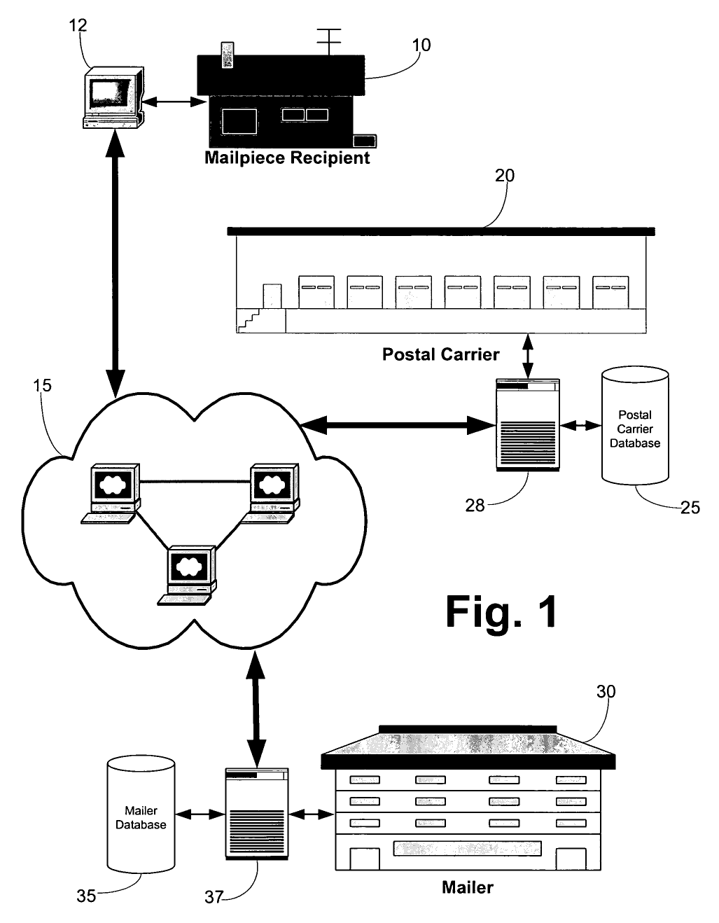

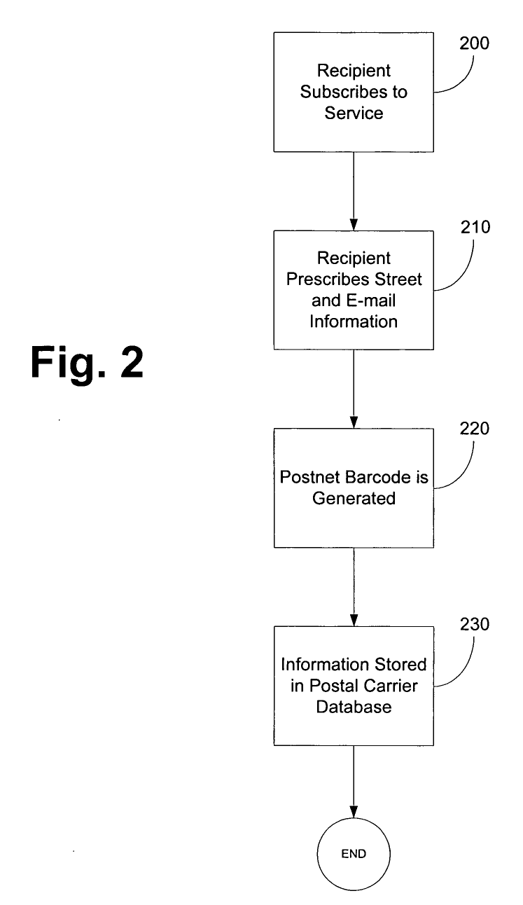

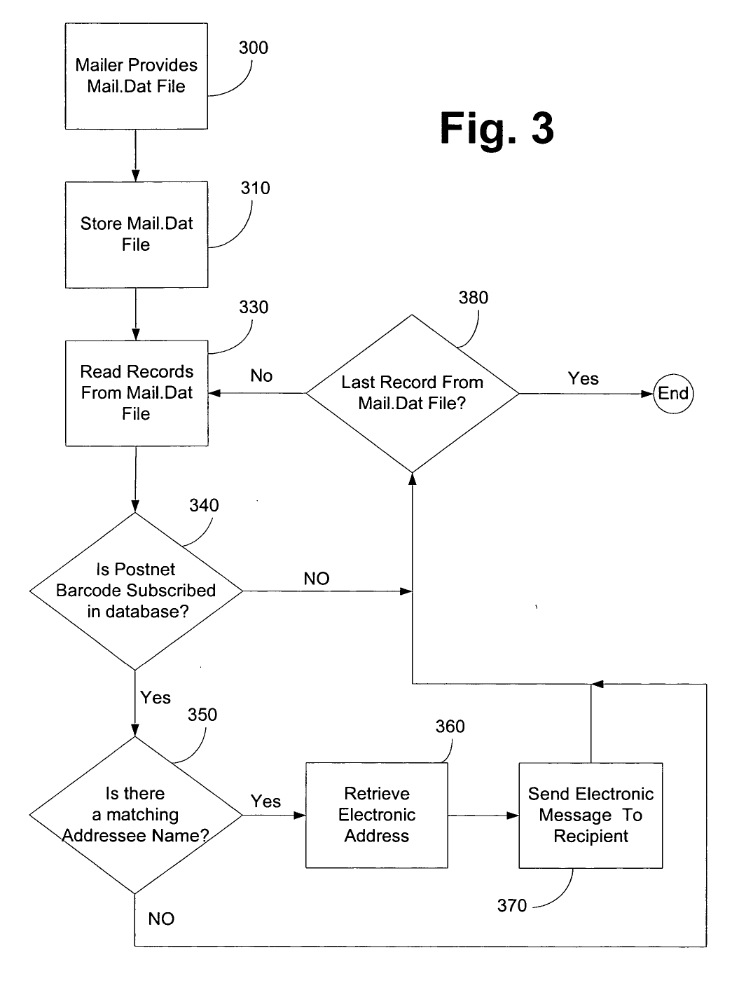

As will be described below, the present invention provides a method wherein a recipient who receives mail delivery from a postal carrier system (e.g., the United States Postal Service (USPS)) can subscribe to a service wherein the postal carrier system will provide them with advanced notification regarding the contents and/or subject of the mailpiece that is currently being processed for delivery or has been deposited with the postal carrier system for delivery to an intended recipient. For ease of description and point of reference purposes, FIG. 1 is provided to illustrate a system level diagram depicting an intended environment of use with the present invention method as described in FIGS. 2 and 3.

Referenced generally by numeral 10 in FIG. 1, a mailpiece recipient is shown who receives delivery of mailpieces from a mailpiece handling system 20. Examples of such mailpiece handling systems can be letter shops were mailpiece are assembled and/or sorted, express delivery carriers (e.g., USPS, FedEx, DSL, etc) or the local government or private postal carriers, such as the U.S. Postal Service. For purposes of description of the preferred embodiment, such a mailpiece handling system will hereafter be generally referred to as a postal carrier system 20.

Recipient 10 is shown to include a PC 10, which amongst other capabilities, is capable of sending and receiving email messages via the Internet 15. It is of course to be appreciated that it is understood that there are a plurality of recipients who receive their mailpiece delivery from postal carrier 20, but for ease of illustration, only a single recipient 10 is depicted. Also, the method for physically delivering mailpieces from a postal carrier system 20 to recipient 10 is well known and need not be further described in any detail.

Postal carrier system 20 preferably includes a database 25 and computer system 28 that are preferably configured to provide the necessary software for storing data relating to recipient prescribed preferences for receiving advanced notification of mailpieces, as discussed in further detail below. It is to be appreciated that each mailpiece delivered by postal carrier system 10 includes printed on it at least one unique identifier. An example of such a unique identifier can be a barcode designating the region of mailpiece delivery for the intended recipient. Typically this barcode is known as the postnet barcode, which is well known and also does need to be further described in detail. Additionally, a mailpiece may include another barcode known as a “Planet Code.” The Planet Code is an additional barcode that is part of the Confirm program from the United States Postal Service. The Confirm service tracks Planet Codes every time they pass through a barcode sorter. The Planet Code identifies the mailer, and the scanning data is transmitted to account holders to notify them as to where in the delivery process the mailpiece is presently located. The Planet Code service does not provide any notification to a mailpiece recipient relating to the contents of mailpieces.

Additionally shown in FIG. 1 is a mailer 30 that typically produces large volumes of mailpieces that are each to be distributed to intended recipients via postal carrier system 20. Typically, mailer 30 produces mailpieces relating to a high volume mail run (e.g., a utility companies monthly billing statements), which mail run is then physically delivered to postal carrier system 20 for subsequent delivery of each contained mailpiece to each intended recipient 10. Each mailpiece contained in a mail run preferably includes a postnet barcode and may also include a Planet Code barcode. Upon receipt of these mailpieces at the postal carrier 10, each mailpiece is scanned to obtain the delivery address for the mailpiece, which scanning particularly detects the aforesaid printed postnet barcode. If a postnet barcode is not provided on the mailpiece by a mailer 30, the postal carrier system 20 can determine preferably through optical character recognition techniques a postnet barcode for the mailpiece, which determined postnet barcode is then printed upon the mailpiece by the postal carrier system 20. Once the postnet barcode for a mailpiece is recognized by the postal carrier system 20, the mailpiece is then cause to be routed through the proper delivery channels within the postal carrier system 20 so it is timely delivered to its intended recipient 10.

To provide enhanced delivery of its generated mailpieces, a mailer 30 preferably provides to postal carrier system 20 an electronic file (e.g., a mail.dat file) preferably including specific information relating to each mailpiece delivered to the postal carrier system 20 from mailer 30. For purposes of describing the preferred embodiment of the present invention, the aforesaid electronic file will hereinafter be referred to as a mail.dat file. Preferably, each mailpiece contained in the corresponding mailrun has an electronic record created for it in the mail.dat file, as set forth further described below. It is to be appreciated that a mail.dat file is a current mailing industry standard for transferring information about mailpieces from one mailing program (e.g., the mailer 30) to another mailing program (e.g., the postal carrier system 20). The mail.dat file is preferably used by the postal carrier system 20 for electronic acceptance, verification and payment purposes. Amongst other information, the mail.dat file preferably includes a respective record containing the postnet, addressee name and subject matter information relating to the contents of a mailpiece for each mailpiece provided in a mail run and recorded in the corresponding mail.dat file.

Further, and in accordance with the present invention, preferably included in the mail.dat file (electronic file) is a URI that is intended to be electronically provided to a recipient as set forth below. Preferably, the URI, when provided to a recipient's PC 10, directs the recipient 10 to a web page on the internet that may or may not be related to the contents of the mailpiece which is to be delivered to the recipient 10. Examples of such web pages are: a preview of the mailpiece, related (or unrelated) advertising and marketing material, a survey, invitation to electronic billing and payment services, a request to modify or cancel delivery of mailpiece, etc. It is to be appreciated that this URI may be the same or generic for each mailpiece contained in the mail run, or it may be customized for each respective recipient in the mail run. In the event the URI is customized for each respective recipient 10, then each aforesaid record contained in the mail run may preferably include a URI customized in some capacity for the respective mailpiece recipient for that record.

With the system components relating to the present invention method being described above, the method of the present invention for providing advanced notification of the contents of a mailpiece to a recipient will now be described.

With reference now to FIG. 2, when a recipient 10 desires to receive the aforesaid advanced notification regarding the subject matter of a mailpiece being delivered to him, the recipient preferably first subscribes to this advanced notification service offering (step 200). In a preferred embodiment, this service is preferably offered via the postal carrier system 20. In subscribing to this service, the recipient preferably provides: 1) a street address to which mailpieces are sent to of which the recipient desires to receive advance notification regarding the mailpiece subject matter; and 2) an email address to which the advanced notification message is to be sent to (step 210). Based upon the street address provided in step 210, a postnet barcode is determined that corresponds to this given street address (step 220). Preferably in indexed format, the above information (street address and email address (step 210) and determined postnet barcode (step 220)) are stored in the database 25 associated with the postal carrier system 20 (step 25). Preferably, the above subscriptions steps (steps 200-230) are performed via the Internet, but rather may also be performed by other communication means (e.g., telephony, facsimile, mail, etc.) capable of providing the aforesaid recipient's information to the postal carrier system 20.

It is noted that while step 210 specifies that a recipient prescribe an email address for receiving advanced notification of a mailpiece to be delivered, it is to be understood that other types of electronic communication channels may be utilized for providing this notification (e.g., a telephony message, facsimile message, pager message, wireless SMS message (i.e., txt message), etc.) Further, it is to be understood that a recipient may prescribe more than one type of a communication channel. For example, a recipient may desire to receive both an email message and a txt message providing notification of the subject matter of mailpiece being delivered. However, for ease of description, only an email communication channel is discussed below in conjunction with the described preferred embodiment.

With the steps discussing how a recipient 10 subscribes to receive advanced notification regarding the contents of a mailpiece being described above, the steps for providing the advanced mailpiece notification to the recipient 10 will now be discussed. With reference to FIG. 3, and starting at step 300, after a mailer preferably 30 generates a mail run containing a plurality of mailpieces, the mailer then provides that mail run and its corresponding mail.dat file to the postal carrier system 20. Typically, the plurality of mailpieces contained in the mail run are physically delivered to the postal carrier 30 while the mail.dat file may either be electronically delivered to the postal carrier (i.e., via the Internet) or physically delivered (i.e., as contained on a tangible medium such as a cd-rom or dvd). The mail.dat file is preferably at least temporarily stored in the database 30 associated with the postal carrier system 25, step 310. After which, processing on each of the plurality of mailpieces is shortly commenced within the postal carrier system 20 so they may be timely delivered to each respective intended recipient 10. It is to be appreciated that the physical processing of the mailpieces provided from mailer 30 may start before, concurrently with or after the below steps are performed for determining whether advanced notification is sent to a mailpiece recipient 10.

Next, in the computer system 28 associated with the postal carrier system 30, the first mailpiece record for preferably the first mailpiece contained in mail.dat file stored in database 25 is accessed to retrieve the postnet barcode, addresses name and subject matter associated with this accessed mailpiece file, step 330. A determination is then made in computer system 28 to determine whether the accessed postnet barcode (via step 330) has been prescribed in postal carrier system database 25 by a subscribing recipient (via step 230), step 340. If yes, then a determination is made as to whether, in addition to the retrieved postnet barcode, is the corresponding retrieved addressee name (via step 330) also prescribed in the database 25 by a subscribing recipient (via step 210), step 350. And if yes, then the postal carrier computer system 28 preferably retrieves the prescribed email address stored in database 25 that is associated with the accessed postnet barcode (via step 210), step 360. Next, an email message is compiled and sent from postal carrier computer system 28 to the retrieved email address (via step 360) associated and prescribed by the subscribing recipient indicating at least that a mailpiece is currently being processed for delivery in the postal carrier system 20 and that the subject matter of this mailpiece relates to the subject matter information listed in the mail.dat file that corresponds to the aforesaid accessed postnet barcode that was retrieved from the mail.dat file (via step 330), step 370.

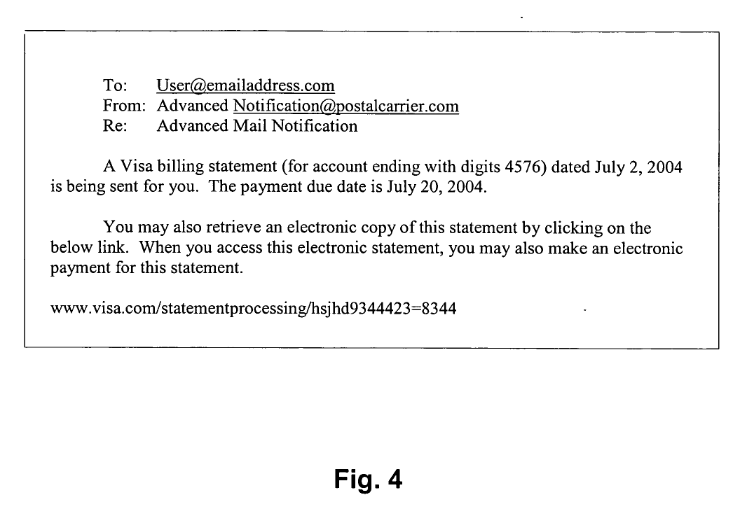

Also included in that email message along with the subject matter information listed in the mail.dat file is the aforesaid URI provided in the mail.dat file step 370. An example of such a message is shown in FIG. 4.

A determination is then made as to whether the aforesaid accessed mailpiece record from mail.dat file was the last record contained therein, step 380. If no, then the above described process then repeats starting at step 330. Also, if in step 340 it was determined that there is no matching postnet barcode, or in step 350 that there was no matching addressee name, then the aforesaid determination for a last mailpiece record at step 380 is performed.

In the drawings-and specification, there have been disclosed a typical preferred embodiment of the invention, and although specific terms are employed, the terms are used in a descriptive sense only and not for purposes of limitation. The invention has been described in detail with specific reference to these illustrated embodiments. It will be apparent, however, that various modifications and changes can be made within the spirit and scope of the invention as described in the foregoing specification and as defined in the appended claims.

What is claimed is:

1. A system for use in a mail handling system for providing mailpiece notification to a mailpiece recipient indicating information corresponding to a mailpiece that has been deposited with the mail handling system, said system comprising:
a computer system associated with said mail handling system
a database associated with said computer system, said database containing prescribed mailpiece addressee information for said recipient and at least one prescribed electronic communication channel address providing for said mailpiece notification;
software executing in said computer system programmed to receive information corresponding to said mailpiece deposited with said mail handling system, said information including a URI, said software capable of determining whether addressee information present on said deposited mailpiece matches a said recipient's addressee information prescribed in said database; and providing notification to said mailpiece recipient via said prescribed at least one communication channel notifying said mailpiece recipient of the received information relating to a mailpiece for said deposited mailpiece if it was determined the addressee information present on said processing mailpiece matches said recipient's addressee information prescribed in said database.

2. A system as recited in claim 1 wherein the mail handling system is the United States Postal System.

3. A system as recited in claim 1, wherein said URI is a web page link.

4. A system as recited in claim 3, said URI references a web page relating to said mailpiece deposited with the mail handling system.

5. A system as recited in claim 1, wherein receiving in said software information relating to at least information relating to said mailpiece being processed includes the step of receiving addressee information from a mailer of said mailpiece that is received separate from said mailpiece.

6. A system as recited in claim 5, wherein receiving in said software information relating to at least information relating to said mailpiece being processed includes the step of receiving from said mailer a recipient's name for said mailpiece that is received separate from said mailpiece.

7. A system as recited in claim 6, wherein receiving in said software information relating to at least information relating to said mailpiece being processed further includes the step of receiving from said mailer a postnet barcode for said mailpiece that is received separate from said mailpiece.

8. A system as recited in claim 1, wherein receiving in said software information relating to at least information relating to at least said mailpiece being processed includes the step of receiving a mail.dat file from a mailer of said mailpiece.

9. A method as recited in claim 4 wherein said web page relating to said mailpiece deposited with the mail handling system includes an electronic image of said mailpiece.

10. A method for providing mailpiece notification from a mail handling system to a mailpiece recipient indicating information corresponding to a mailpiece that has been deposited with the mail handling system for delivery to the mailpiece recipient, said method comprising the steps of:
providing a database containing prescribed mailpiece addressee information for said recipient and at least one communication channel other than mailpiece delivery for providing said mailpiece notification;
receiving in said mail handling system information corresponding to said mailpiece deposited with said mail handling system, said information including a URI;
determining whether addressee information present on said deposited mailpiece matches a said recipient's addressee information prescribed in said database; and
providing notification to said mailpiece recipient via said prescribed at least one communication channel notifying said mailpiece recipient of the received information relating to a mailpiece for said deposited mailpiece if it was determined the addressee information present on said processing mailpiece matches said recipient's addressee information prescribed in said database.

11. A method as recited in claim 10 wherein the mail handling system is the United States Postal System.

12. A method as recited in claim 10, wherein said URI is a web page link.

13. A method as recited in claim 12, said web page link references a web page relating to said mailpiece deposited with the mail handling system.

14. A method as recited in claim 10, wherein the step of receiving in a postal carrier mailpiece delivery system information relating to at least information relating to said mailpiece being processed includes the step of receiving addressee information from a mailer of said mailpiece that is received separate from said mailpiece.

15. A method as recited in claim 14, wherein the step of receiving in a mail handling system information relating to at least information relating to said mailpiece being processed includes the step of receiving from said mailer a recipient's name for said mailpiece that is received separate from said mailpiece.

16. A method as recited in claim 15, wherein the step of receiving in a mail handling system information relating to at least information relating to said mailpiece being processed further includes the step of receiving from said mailer a postnet barcode for said mailpiece that is received separate from said mailpiece.

17. A method as recited in claim 15, wherein the step of receiving in a mail handling system information relating to at least information relating to at least said mailpiece being processed includes the step of receiving a mail.dat file from a mailer of said mailpiece.

18. A method as recited in claim 10 wherein the step of determining whether the addressee information present on said processing mailpiece matches a said recipient's addressee information prescribed in said database is performed without requiring optical scanning of said mailpiece.

19. A method as recited in claim 11 wherein said web page relating to said mailpiece deposited with the mail handling system includes an electronic image of said mailpiece.

20. A method as recited in claim 10 wherein the step of determining whether the addressee information present on said processing mailpiece matches a said recipient's addressee information prescribed in said database includes the step of matching an addressee name provided by said recipient with an addressee name provided by a mailer for said mailpiece.

21. A method as recited in claim 10 wherein the step of providing a database containing the recipient's preferred communication information prescribing at least one communication channel includes the step of prescribing an email address.

22. A method as recited in claim 21 wherein the step of providing notification to said mailpiece recipient includes sending an email message to said recipient prescribed email address.

23. A method for providing mailpiece notification from a postal carrier system to a mailpiece recipient indicating the subject matter of a mailpiece that has been deposited with said postal carrier system for delivery to the mailpiece recipient which mailpiece was deposited with said postal carrier system in a mail run containing a plurality of individual mailpieces from a mailer, said method comprising the steps of:
providing a first database in said postal carrier system that is accessible to a said mailpiece recipient;
providing a computer system in said postal carrier system;
prescribing in said first database by a said intended mailpiece recipient information including recipient's mailpiece address information and an email address prescribing where the recipient desires to receive said mailpiece notification;
generating in said postal carrier computer system a postnet barcode for a said mailpiece recipient based upon and corresponding to said prescribed mailpiece address for said mailpiece recipient;
storing in said first database said generated postnet barcode for said mailpiece recipient;
providing a said mail run to said postal carrier system from a mailer;
providing at least one electronic file to said postal carrier system which said electronic file contains at least each recipient's name, the corresponding subject matter and corresponding postnet barcode for each mailpiece contained in said provided mail run and a URI to an internet web page which said web page relates to said subject matter of said mailpiece deposited with said postal carrier;
determining in said postal carrier computer system whether a prescribed recipient name and said corresponding postnet barcode stored in said first database matches a recipient name and corresponding postnet barcode provided in said electronic file from said mailer; and
providing email notification to said mailpiece recipient via said recipient's prescribed email address notifying said mailpiece recipient of said mailpiece subject matter provided in said at least one electronic file that corresponds to said determined matching recipient name if it was determined said recipient name and said corresponding postnet barcode stored in said first database matches a recipient name and corresponding postnet barcode provided in said electronic file from said mailer.

24. A method as recited in claim 23, wherein the at least one provided electronic file is a mail.dat file.
